(19) United States
(12) Patent Application Publication
(10) Pub. No.: US 2023/0196453 A1
(43) Pub. Date: Jun. 22, 2023

(54) DEDUPLICATION OF ACCOUNTS USING ACCOUNT DATA COLLISION DETECTED BY MACHINE LEARNING MODELS

(71) Applicant: Brex Inc., Draper, UT (US)

(72) Inventor: Eric Shiu, Milpitas, CA (US)

(21) Appl. No.: 17/560,053

(22) Filed: Dec. 22, 2021

(51) Int. Cl. G06Q 40/02; G06F 16/215; G06F 16/22; G06F 16/28

(52) U.S. Cl. CPC G06Q 40/025; G06F 16/215; G06F 16/2255; G06F 16/285

(57) ABSTRACT

There are provided systems and methods for deduplication of accounts using account data collision detected by machine learning models. An entity, such as a company or other entity, may purchase items utilizing a payment instrument or card provided to the company by a credit provider system or entity. In order to provide proper underwriting for credit extensions, such as balances and limits of extendable credit, the credit provider system may utilize an intelligent machine learning system for data deduplication to prevent account data and balances from being overcounted. The machine learning system may include models to analyze account metadata to determine if key collisions exist between account metadata. Further, the machine learning system may utilize transactions to pair accounts based on key collisions between transactions. If duplicate accounts or balances are detected, the service provider may deduplicate the accounts to prevent overextending services to entities.

### TECHNICAL FIELD

The present application generally relates to intelligent machine learning (ML) models and systems and more specifically to training and utilizing one or more ML models for deduplication of account data in computing systems.

### BACKGROUND

Service provider systems may provide services to customers, such as businesses and companies, through computing systems and networks. These services may include credit or loan underwriting that may extend a balance to customers repayable at set billing cycles in return for the risk (and corresponding fees or payment) that is taken by extending such a balance. The service provider may track customer data using expense management software, hardware, and other infrastructure to manage expenses and control user transactions. This customer data may include account data associated with various financial accounts, assets, debts, spend or burn rates of funds, and the like. However, if accounts and/or account data are duplicated in a computing architecture, systems, and/or databases of the service provider, the provided services to customers may be incorrect. This may occur either by accident or by malicious users, customers, and/or businesses (e.g., fraudsters). Conventional service provider systems may rely on detecting the same account identifiers or data in order prevent duplicate account data that incorrectly extends services to users. For example, conventional systems may merely analyze whether a bank account number is the same between different account data to deduplicate this data. However, with data that is obtained and/or extracted from multiple separate and/or distinct computing systems and/or entities, the data may be incomplete, in different data formats, and/or incompatible.

Therefore, there is a need to address deficiencies with conventional computing systems used by service providers to deduplicate data in computing systems for proper data processing.

### BRIEF DESCRIPTION OF THE DRAWINGS

FIG. 1 is a block diagram of a networked system suitable for implementing the processes described herein, according to an embodiment;

FIG. 2 is an exemplary diagram of layers of a machine learning model trained to perform account data deduplication, according to an embodiment;

FIG. 3 is an exemplary diagram of a workflow for a machine learning model train to perform account data deduplication, according to an embodiment;

FIG. 4 is an exemplary flowchart for deduplication of accounts using account data collision detected by machine learning models, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for deduplication of accounts using account data collision detected by machine learning models. Systems suitable for practicing methods of the present disclosure are also provided.

In service provider systems, such as credit provider systems and other financial service providers, underwriting systems may be utilized to extend credit or other loans to customers and other entities, such as businesses and companies, based on risk assessment and risk analysis processes performed by the service provider systems. With new companies, such as start-up businesses and enterprises, underwriting systems may require up-to-date and correct financial data for entities in order to perform accurate risk analysis for the underwriting systems. This may include financial account data, such as data for different bank accounts, assets, debts, incoming and/or outgoing funds and rate of those funds incoming/outgoing, and the like. Further, the start-up businesses may have different and difficult to ascertain resources and financial accounts, which may further affect underwriting procedures. If account data becomes duplicated and financial balances are not correct, underwriting procedures may be incorrect. For example, double or triple-counting balances may cause the service provider to become overexposed and overextend a credit limit to an entity. This may be accidental or may be intentional by malicious parties. This may also affect compliance with credit policies, such as a capital markets credit policy.

In order to solve these issues with account data duplication, intelligent decision-making in whether account data has been duplicated may be performed using machine learning (ML) models that may determine and/or predict whether account data has been duplicated. One or more ML models may take, as input, features and parameters for a business's or other entity's available account data and/or metadata, and may make, based on training data features and trained ML model layers, a determination of whether there is duplicated account data for the entity that may cause multiple counting of an account balance that may cause incorrect underwriting and extension of credit or other funds. The one or more ML models may further use, as input, transactions and transaction data for transactions processed by different accounts when determining whether there is duplicated account data for the entity. This allows a processing engine and operations of the underwriting system to deduplicate account data in a predictive manner in order to correctly forecast and determine underwriting for the entity

An online credit and expense management system may provide data aggregators that monitor an entity's bank accounts and other financial accounts to determine available balances for the entity. The financial accounts may include one or more credit accounts, debit cards, direct debit/credit through automated clearing house (ACH), wire transfers, gift cards, and other types of funding sources that may be issued to the entity by the online system and/or other financial service providers (e.g., banks). Thus, a networked system and provider may include a framework and architecture to provide payment gateways, billing platforms, eCommerce platforms, invoicing, and additional services. For example, a credit and underwriting provider system may offer services, software, online resources and portals, and infrastructure used to provide underwriting for the entity's (e.g., a business or company) available credit or loans, as well as operations for expenses, purchases, and other financial transactions.

The credit provider system may provide an electronic data processing framework that integrates into a payment network and/or computing system of a financial service provider at a point that allows for real-time data acquisition and/or periodic data retrieval and/or updating of available balances for financial accounts of the entity. For example, integration of the framework at a network node or point at or between an issuing and/or acquiring bank for one or more payment networks may allow for data about accounts and balances for an entity to be received in real-time, and thus the framework may perform real-time data processing. The data for financial accounts, balances, and/or transactions may also be acquired at certain intervals, such as from a pull and/or retrieval for the request from the corresponding banking system for the entity. Additionally, the system's framework may integrate with one or more client devices (e.g., personal computers, mobile devices, etc.), online scheduling resources, personnel management systems, and/or enterprise business software to receive data for an entity that is associated with financial accounts, balances, and/or processed transactions. The payment networks may correspond to resolution networks for payment processing using an account identifier, payment card, or the like during electronic and in-person transaction processing. These payment networks and financial service providers (e.g., banks and banking computing systems) may be selected and integrated with in order to determine and process account and/or transaction data in order to perform predictive account deduplication, as discussed herein.

In this regard, an entity, such as a company or other organization, may request credit underwriting and extension of credit from an underwriting system of a credit service provider, e.g., through a loan or credit account that provides one or more payment cards or other financial accounts. Initially, the entity may be onboarded by providing necessary documents to verify the entity's identity and/or business standing, such as incorporation documents, Employer Identification Number (EIN), tax status and/or documents, and the like. In order to be processed for credit underwriting, the entity may further be required to provide certain data regarding the entity's financial status, accounts, and balances, such as initial seed money, investments, and global available balance(s) that may be used for repayment of extended credit or loans. In this regard, the entity may provide access or a link to, such as through an integration with one or more banking systems utilized by the entity, one or more available balances of funds.

However, financial balances and available accounts may cause underwriting rules and models to determine and output credit extensions based on the available data. When the available data is incorrect, such as if accounts have been duplicated in processing systems, the credit extensions may be incorrect. Thus, the service provider may train one or more ML models in order to identify duplicated account data, such as when account balances have been counted and used multiple times during underwriting. When training an ML model, extracted features from training data are used at an input layer, which is then used to weigh, balance, and assign values to nodes within hidden layers of the ML model. The training data may include annotated or unannotated data, for supervised or unsupervised learning, respectively, which is used to train and adjust each node. Each node may represent a mathematical relationship to other nodes within the model and between interconnected layers that represent decisions, such as in a decision tree. For example, an input layer may be interconnected to nodes within a first hidden layer, which may then be interconnected to nodes within a next hidden layer, and so on until an nth-hidden layer is the final hidden layer. This nth-hidden layer is then connected to output nodes or decisions, which provide a prediction, output score, or the like that is learned from the training data by a computing system. Feedback from one or more data scientists may be used to adjust the value, weight, and/or relationship of nodes and more accurately provide predictions, scores, or the like. Once trained, the ML model(s) may be deployed in an intelligent account data deduplication system, which may provide predictive analysis without user input identifying duplicated account data and/or balances and deduplicating the data in the service providers systems.

In order to provide intelligent deduplication of account data and/or account balances in a service provider and/or credit underwriting system, the service provider may utilize a multi-step or level ML engine and system that provides account metadata dedupe and transaction dedupe through one or more ML models. With the account metadata analysis, information such as an account number, routing number, banking or financial institution name, and the like may be used to train an ML model to detect duplicate account data. Other account metadata may be any data that identifies, describes, and/or is associated with creation, usage, and/or maintenance of the account. The account metadata may also be used after ML model training as input to perform or provide a predictive analysis and/or score from an output layer of the ML model. Although there may be an order of hundreds of thousands of individual data pieces or elements for the account metadata, this may be a lower data volume than the transaction data, which may include hundreds of millions of individual data elements. In order to perform the ML model predictions or score for account data duplication (e.g., identification of duplicate account data), a multiple imputation strategy may be used with one or more ML or neural network (NN) algorithms that allows for an iterative training and decision-making process that allows building of a classification algorithm and/or model. In some embodiments, the strategies may include natural language processing (NLP) for keyword extraction and/or named entity recognition (NER). Keyword extraction may be used to extract specific strings from metadata. NER may be used to identify certain names within the metadata (e.g., a name of a user or owner of an account, a banking or other financial institution, etc.). For each strategy, key collisions may be checked for collisions between data, hashes or keys of data, and the like. This may allow for a fast and vectorized implementation.

However, where account metadata dedupe may be insufficient or may miss certain duplication accounts and/or account balances. In this regard, transaction data may include data and metadata from individual transactions, including a transaction date, description, amount, items in the transaction, shipping and/or billing dates, payment instruments used in the transaction, information from a receipt or transaction history (e.g., merchant name, location, merchant category code, etc.), and the like. The transaction data may only be pulled when necessary, and the data may be cleaned after pulling (e.g., by removing unnecessary or extraneous data, filling in missing portions, formatting into a standard format, and the like). An account distance metric may be determined based on transaction collisions to determine a distance between transactions. This may be used to compute a pairwise similarity between accounts and build an affinity matrix. Thereafter, an agglomerative clustering algorithm and model may be used to group those accounts having transactions that may meet or exceed a similarity threshold. In some embodiments, during the agglomerative clustering and grouping of accounts, fuzzy matches may be allowed based on transaction data. Thus, the ML model system allows for smart and fuzzy matches using account metadata for comparison between accounts in certain embodiments, as well as transaction data in further embodiments. Data accrued over time for accounts and balances of the entity may be continually monitored by the service provider's account deduplication system in order to eliminate duplicate account data that may affect provided credit underwriting and extension. Thus, the ML model systems of the service provider may provide intelligent and automated deduplication of data in computing systems and database storages, which provides more up-to-date and accurate data for data processing systems. This provides improved performance of computing systems, reduces data storages of duplicate data, and provides faster and automated data deduplication (e.g., without manual efforts).

Once duplicated accounts, balances, and/or account data are identified using the ML model system, data for those accounts may be deduplicated within the service provider's computing systems and architecture. This may include automatic deduplication and deletion in one or more databases and/or data stores. In some embodiments, prior to deduplication and deletion, one or more alerts may be set, and data with other systems, such as an underwriting and credit determination system, may be automatically updated. This may include providing and/or adjusting an extension of credit or other available balance. In order to use this extension of credit, one or more payment instruments may be issued to users or employees of the entity, including sales, management, information technologies, or other employees. The payment instruments may correspond to various types of payment cards and/or account identifiers, which may be issued by the service provider system or by an associated partner (e.g., an issuing bank that provides credit cards or other financial instruments). During the course of business, an employee may engage in commerce with one or more merchants using a payment instrument, such as by making an in-person (e.g., at a merchant location or store) or online purchase from the merchant. Thus, the user may request electronic transaction processing through the account number or payment instrument identifier(s) provided to the user. Merchants (e.g., a seller or payment receiver, such as a business, fundraiser, healthcare provider, landlord, etc.) may correspond to any person or entity selling goods and/or services (referred to herein as an “item” or “items”).

When using the extended credit to process a payment, the credit provider system may receive transaction data for the payment request from the payment network, for example, when the acquirer (e.g., the acquiring bank for the merchant that processes the payment instrument provided by the user) requests processing with the issuer (e.g., the issuing bank of the entity and/or credit provider system that issues the payment instrument). This occurs when the user causes a transaction to be generated, and the merchant generates a total for the transaction request, which the user can pay for by providing a payment instrument to the merchant. After receiving the payment instrument, the merchant may cause a payment request to be generated for payment of the transaction. In various embodiments, the user may be required to enter additional checkout information, such as a name, delivery location, or other personal or financial information that may be included in the transaction data for the transaction. In some embodiments, the payment instrument may previously be tokenized by the expense management system in order to further protect from fraud, where the digital token allows for backend identification of the payment instrument to the issuer and/or expense management system without exposing payment credentials.

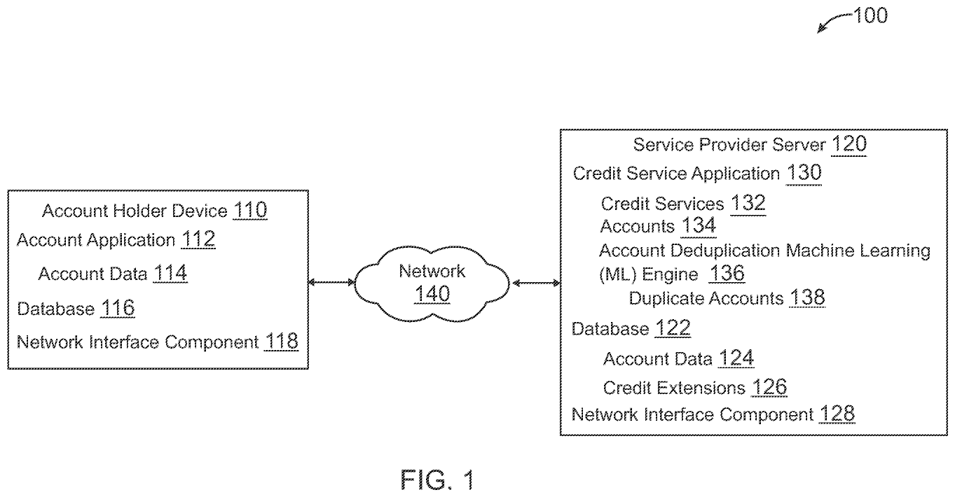

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways, and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a customer or account holder device 110 and a service provider server 120 in communication over a network 140. A user (not shown) may correspond to an employee, contractor, shareholder, or other suitable person of a company (not shown and generally referred to herein as an “employee”) associated with account holder device 110, which may utilize a credit account for a credit limit or balance extended by service provider server 120. Service provider server 120 may extend this credit based on account data and balances for the company or other entity. Deduplication of the account data to provide proper underwriting may be performed by service provider server 120.

Account holder device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Account holder device 110 may be utilized by an employee of an entity or company that employs one or more users. Account holder device 110 may be used to manage and/or utilize a credit account and extended line of credit or other loan for funds from service provider server 120. For example, in one embodiment, account holder device 110 may be implemented as a personal computer (PC), telephonic device, a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. In this regard, account holder device 110 includes one or more processing applications which may be configured to interact with service provider server 120 to manage accounts, account data, and/or underwriting, such as through providing account data and/or assisting with deduplication of account data. Although only one communication device is shown, a plurality of communication devices may function similarly.

Account holder device 110 of FIG. 1 includes an account application 112, a database 116, and a network interface component 118. Account application 112 may correspond to executable processes, procedures, and/or applications with associated hardware. In other embodiments, account holder device 110 may include additional or different modules having specialized hardware and/or software as required.

Account application 112 may be implemented as specialized hardware and/or software utilized by account holder device 110 to access an account and provide data for the account, such as a credit account for an entity associated with account holder device 110 that is provided and managed by service provider server 120. In this regard, account application 112 may correspond to software, hardware, and data utilized by a user associated with account holder device 110 to request a line of credit or other credit extension, as well as enter, store, and process account data 114 for one or more financial accounts available to and/or controlled by the entity (e.g., a bank account, available investments and/or raised capital from rounds of investing, and other financial accounts). Account data 114 may correspond to global available funds for the entity associated with account holder device 110, and may further include account metadata associated with the available accounts of the entity. Account data 114 may also include transaction histories and other transaction data and/or metadata. Account application 112 may be used to retrieve and/or access account data 114 from an external financial institution or computing system and provide the data to service provider server 120. However, account application 112 may also be used to authorize service provider server 120 to access account data 114 from these financial institutions and systems. Account application 112 may be integrated with service provider server 120 so that data may be shared with service provider server 120 for account data 114 periodically or on command and/or for establishing an integration between service provider server 120 and those account providers and financial institutions.

In various embodiments, account application 112 may include a general browser application configured to retrieve, present, and communicate information over the Internet (e.g., utilize resources on the World Wide Web) or a private network. For example, account application 112 may correspond to a web browser, which may send and receive information over network 140, including retrieving website information, presenting the website information to the user, and/or communicating information to the website, including payment information. However, in other embodiments, account application 112 may include a dedicated application of service provider server 120 or other entity, which may be configured to assist in establishing and maintaining credit accounts, providing account data 114, requesting and/or assisting in deduplication of accounts and/or balances, and/or utilizing credit extended based on account data 114 and/or account balances.

Account holder device 110 may further include database 116 stored in a transitory and/or non-transitory memory of account holder device 110, which may store various applications and data and be utilized during execution of various modules of account holder device 110. Thus, database 116 may include, for example, identifiers such as operating system registry entries, cookies associated with account application 112, identifiers associated with hardware of account holder device 110, or other appropriate identifiers, such as identifiers used for payment/account/device authentication or identification. Database 116 may include account data 114 input and stored by account holder device 110 and/or accessed and retrieved from an external computing system of a financial institution.

Account holder device 110 includes at least one network interface component 118 adapted to communicate with service provider server 120 and/or another device or server. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices.

Service provider server 120 may be maintained, for example, by an online service provider, which may provide credit or loan underwriting services to companies, businesses, and other entities. In this regard, service provider server 120 includes one or more processing applications which may be configured to interact with account holder device 110, financial institutions, and other devices or servers to facilitate provision of credit or other loans and funds, processing of payments, and deduplication of account data to properly provide credit underwriting and other financial services. In one example, service provider server 120 may be provided by BREX®, Inc. of San Francisco, Calif., USA. However, in other embodiments, service provider server 120 may be maintained by or include other types of credit providers, financial services providers, and/or other service provider, which may provide such services to customers, businesses, and other entities.

Service provider server 120 of FIG. 1 includes a credit service application 130, a database 122, and a network interface component 128. Credit service application 130 may correspond to executable processes, procedures, and/or applications with associated hardware. In other embodiments, service provider server 120 may include additional or different modules having specialized hardware and/or software as required.

Credit service application 130 may correspond to specialized hardware and/or software to allow entities (e.g., the entity associated with account holder device 110) to request and/or obtain a credit balance based on credit underwriting, which may be used through issued payment instruments associated with an account and funding for the entity. Credit service application 130 may further provide management for credit underwriting and credit balances via credit services 132, which may also include deduplicating data through intelligent ML models and engines to prevent, reduce, and/or reverse overcounting of account balances and other available funds or financials for the entity when performing credit underwriting via credit services 132. Credit services 132 may therefore correspond to a set of computing, underwriting, and other services associated with extending and maintaining credit to entities (e.g., businesses, companies, customers, and the like). In this regard, an entity may first establish an account with credit service application 130 by providing company, account, and/or other entity data and onboarding using credit services 132. Such information may include bank account and funding information, such as verified funding from investors, available funds directly in an account with a bank or other financial institution, available future funds and/or balances, and/or other financial balances and the like. If qualified based on underwriting policies, rules, and/or models, credit services 132 may provide credit underwriting, and service provider server 120 and/or another issuing entity may provide one or more payment instruments for the line of credit or other loan that is managed by credit service application 130. For example, credit services 132 may issue one or more credit cards for employees of the entity, which may correspond to a real or virtual credit card or other types of payment instruments and instrument identifiers that may be used for company payments.

However, proper credit underwriting and/or compliance with credit policies may require service provider server 120 to deduplicate accounts, account balances, and/or other account data for accounts 134. Accounts 134 may correspond to a set of financial accounts, bank accounts, and/or other accounts that may be associated with a funding balance available to the entity and used to determine credit underwriting amounts based on one or more rules engine, model-based engine, and/or policies. Thus, credit service application 130 further includes an account deduplication ML engine 136 that may perform account deduplication of accounts 134 in order to provide credit underwriting and/or dynamically adjust credit limits and extended balances is one or more of accounts 134 and/or their corresponding balances have been overcounted based on duplicate account data. In this regard, account deduplication ML engine 136 may include one or more processes to train and implement account deduplication ML models for account deduplication ML engine 136, which may correspond to ML models that may generate predictions, correlations, and/or account deduplication scoring based on account metadata and/or transaction data. In various embodiments, one or more of the account deduplication ML models may correspond to a multiple imputation strategy using one or more ML algorithms for iterative training and/or decision-making based on account metadata. The multiple imputation strategy may, for each strategy and/or ML algorithm/model, check for key collisions between data features and/or attributes, such as individual parameters and features from account metadata. These features may be vectorized, computed to a key or hash, or the like for the multiple imputation strategy. Thereafter, a classifier of the account metadata for accounts 134 may be provided as an output for the one or more ML algorithms using the multiple imputation strategy with account metadata as duplicate accounts 138. Duplicate accounts 138 may correspond to those accounts that have overcounted account data and/or balances, such as when the data for duplicate accounts 138 for one or more entities may exist and/or occur twice with service provider server 120, which may adversely affect credit services 132 when performing credit underwriting.

Further, the ML models of account deduplication ML engine 136 may also utilize transaction data when necessary (e.g., where account metadata does not provide complete or acceptable levels/thresholds of account deduplication, where account metadata is incomplete, etc.). The transaction data may be used as a secondary ML model system of account deduplication ML engine 136, which may provide additional and/or fallback ML model decision-making and/or classification of whether accounts 134 include duplicate accounts 138. When using transactions processed by accounts 134 to identify duplication accounts 138, an account distance metric may be determined based on transaction collisions occurring between transactions. Thereafter, an agglomerative-clustering algorithm may be used to track and identify primary and/or duplicated account data for duplication accounts 138. In various embodiments, the account metadata and/or transaction data may require cleaning before use, such as to format data, determine incomplete and/or missing data, add the incomplete and/or missing data, and the like.

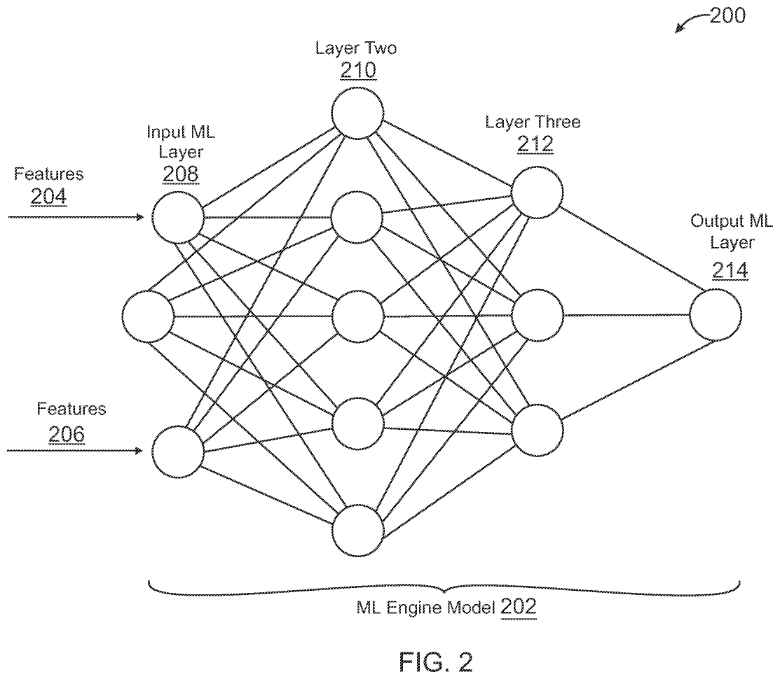

Different layers of account deduplication ML models may then be trained using the features, as discussed in further detail with regard to FIG. 2. Once trained, account deduplication ML engine 136 may be used to identify duplicate accounts 138 and remove the duplication account data and/or balances for duplicate accounts 138 from use by credit services 132 and/or storage by database 122. This may include providing an initial underwriting decision and/or credit balance, as well as dynamically adjusting credit limits if account data and/or balances have been overcounted. Thereafter, account deduplication ML engine 136 may adjust credit balances provided by credit services 132 and/or provide automated data deduplication and removal from systems and storages of service provider server 120.

Credit services 132 may further correspond to specialized hardware and/or software to allow entities (e.g., the entity associated with account holder device 110) to process financial transactions using one or more company credit cards or other financial instruments issued to one or more entities for a credit limit. Credit services 132 may therefore correspond to one or more processes to receive transaction data, which may include information about the transaction (e.g., cost, items, additional fees including tax or tip, merchant identifier, description, and the like), an identifier for the entity associated with account holder device 110, and/or the used payment instrument (e.g., credit card number for the credit account). Credit services 132 may then utilize one or more payment networks to process the transaction, such as by issuing a payment over a payment network and/or by requesting payment by a credit issuing bank or institution to the merchant and/or acquiring bank or institution. In other embodiments, the credit card and payment network may be managed by another entity and/or payment network, where an integration by service provider server 120 with the network may allow for acquisition of transaction data by credit services 132. Credit services 132 may further issue transaction histories and provide accounting and recordation of transaction data. In various embodiments, data accrued from credit services 132 may further be used as additional information for account deduplication ML engine 136 when identifying and deduplicating duplicate accounts 138.

Additionally, service provider server 120 includes database 122. As previously discussed, the user, entity, and/or entity corresponding to account holder device 110 may establish one or more accounts associated with account data 124 with service provider server 120, which may be used to underwrite credit extensions 126. account data 124 in database 122 may include entity information, such as name, address, payment/funding information, additional user financial information, and/or other desired entity data. Account data 124 may further include information used during ML model decisions for account deduplication, such as account metadata and transactions. Database 122 may also be used to store transaction data and information on issued payment instruments to entities and transactions processed using those instruments.

In various embodiments, service provider server 120 includes at least one network interface component 128 adapted to communicate with account holder device 110 and/or other devices or servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices.

In various embodiments, one or more of the devices, systems, and/or components of system 100 may one or more computing systems or architectures of a banking or financial institution. For example, the financial institutions may include a computing system and/or network utilized for funding balances within accounts, such as bank and/or financial accounts of funds available to business entities. The financial institution(s) may further provide resolution of payment requests and electronic transaction processing, which may be governed by permissions (e.g., acceptances and denials) of payment requests for transaction processing by service provider server 120. In this regard, the financial institution(s) may provide one or more accounts that include balances available to an entity associated with account holder device 110, such as bank accounts and other accounts that include assets of the business entity. A financial institution may correspond to an acquiring and/or issuing bank or entity that may hold accounts for users and/or assist in resolving payments. The system(s) of the financial institutions may include one or more processing applications which may be configured to interact with account holder device 110 and/or service provider server 120 to provide account data and balances used for account deduplication.

Network 140 may be implemented as a single network or a combination of multiple networks. For example, in various embodiments, network 140 may include the Internet or one or more intranets, landline networks, wireless networks, and/or other appropriate types of networks. Network 140 may correspond to small scale communication networks, such as a private or local area network, or a larger scale network, such as a wide area network or the Internet, accessible by the various components of system 100.

FIG. 2 is an exemplary diagram 200 of layers of a machine learning model trained to perform account data deduplication, according to an embodiment. As shown, diagram 200 includes three groupings of layers—an input ML layer 208, hidden layers having a layer two 210 and a layer three 212, and an output ML layer 214 having one or more nodes, however, different layers may also be utilized. Diagram 200 includes representations of nodes interconnected to nodes in other layers in a similar manner to a decision tree, however, using one or more ML algorithms and trainers, a combination of such algorithms and/or trainers, and/or deep learning algorithms and/or NN models. In this regard, diagram 200 can have less or as many hidden layers as necessary or appropriate in order to provide proper decision-making, which may include using ML model training functions and algorithms.

Decision trees utilized by certain ML models, such as an XG Boost model, may include nodes that are trained using a mathematical algorithm to assign different weights and/or values for decision-making at decision nodes to provide output at output nodes. Decision nodes may include an initial input node and hidden nodes with additional decision-making when arriving at an output decision and node. Therefore, initial input information or feature(s) may be provided, which may cause a decision to be made based on the mathematical representation (e.g., computation or algorithm) of the decision at the input decision node. For example, an input decision node may be connected to additional nodes in one or more additional hidden layers. A decision may be performed based on the training dataset that allows for attributes in the values of the input to be compared to the root attributes of training data set. Based on the comparison and the mathematical model and algorithm, a decision may be made to proceed to a following node in the decision tree, which may include subtrees and/or outputs. Subtrees may be used for further decision-making and outputs based on weights and algorithms for each node when taking the input values and/or vectors. Thus, a decision tree may cause an output based on the trained nodes and their corresponding values, weights, or representations in the trained ML model for the decision tree. A representation of multiple algorithms that may be used to generate input, hidden, and output layers, and their corresponding nodes as shown in diagram 200 of FIG. 2.

Similar to a decision tree, nodes are connected to nodes in an adjacent layer in ML engine model 202. In this example, ML engine model 202 of diagram 200 receives a set of input values and produces one or more output values, for example, a decision, categorization, classification, or score of whether compared account data used as input has been duplicated in a computing system. However, different, more, or less outputs may also be provided based on the training. When ML engine model 202 is used, each of input features 204 and 206 in input ML layer 208 may correspond to a distinct attribute or input data type derived from the training data regarding account metadata or transactions/transactional data.

In some embodiments, each of layer two 210 and layer three 212 in the hidden layers generates a representation, which may include a mathematical computation (or algorithm) that produces a value based on the input values of the input nodes. The mathematical computation may include assigning different weights to each of the data values received from input features 204 and 206. Layer two 210 and layer three 212 may include different algorithms and/or different weights assigned to the input data and may therefore produce a different value based on the input values. Hidden layers include two layers for layer two 210 and layer three 212, and each node in a layer two 210 may be connected to the nodes in the adjacent hidden layer for layer three 212 such that nodes from input ML layer 208 may be connected to nodes in layer two 210, nodes in layer two 210 may be connected to nodes in layer three 212, and nodes in layer three 212 may be connected to an output node in output ML layer 214. The values generated by the hidden layer nodes may be used by the output layer node to produce an output value for diagram 200.

Diagram 200 may be trained by using training data, including data associated with account metadata associated with accounts reviewed and/or managed by a service provider when performing account deduplication using account metadata. Diagram 200 may also or instead be trained using transactions and other transactional data for and/or processed using the accounts. Those accounts may correspond to accounts reviewed and/or managed by the service provider to determine account balances, which may affect credit underwriting for entities associated with the accounts. Data may be prepared by extracting features and attributes from the data, which may also be prepared by converting data to numerical representations and vectors. Further, data may be cleaned, pruned, or otherwise removed of outlier data. By providing training data to diagram 200, the nodes in the hidden layers of layer two 210 and layer three 212 may be trained (adjusted) such that an optimal output (e.g., a classification) is produced in the output layer based on the training data. By continuously providing different sets of training data and penalizing diagram 200 when the output of diagram 200 is incorrect, diagram 200 (and specifically, the representations of the nodes in the hidden layer) may be trained (adjusted) to improve its performance in data classification. Adjusting diagram 200 may include adjusting the weights associated with each node in the hidden layer.

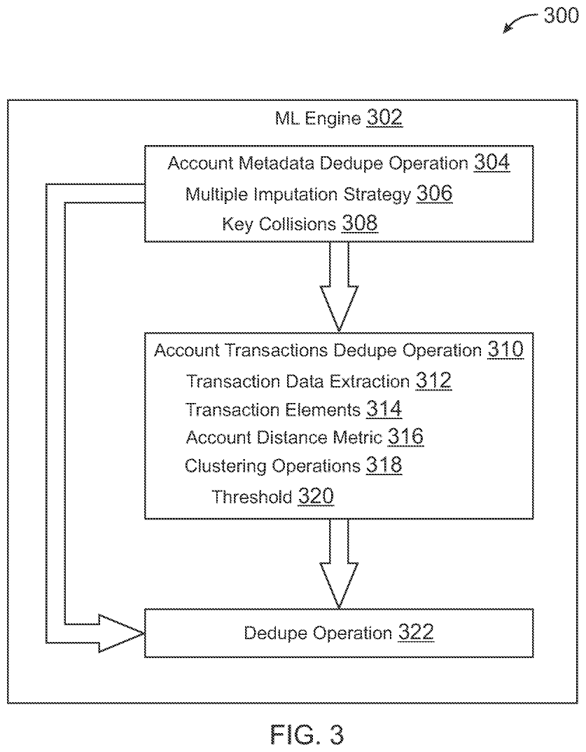

FIG. 3 is an exemplary diagram 300 of a workflow for a machine learning model trained to perform account data deduplication, according to an embodiment. Diagram 300 of FIG. 3 includes a representation of a workflow of operations during account deduplication performed by service provider server 120 using credit service application 130 discussed in reference to system 100 of FIG. 1. In this regard, the account deduplication may be performed using one or more ML models, such as those trained in regard to the representations of FIG. 2.

In diagram 300, initially an ML engine 302 may implement one or more ML models for account deduplication, which may utilize a sequence of operations to deduplicate accounts based on different data and therefore execute a dedupe operation to dedupe, delete, and/or change account data for accounts and/or balances that may have been duplicated. In this regard, ML engine 302 may initially use an account metadata dedupe operation 304 that utilizes a multiple imputation strategy 306 to identify key collisions. In this regard, multiple imputation strategy 306 may use one or more ML models, trainers, and/or algorithms, which may further utilize a combination of such ML algorithms in order to identify key collisions between account metadata.

For example, multiple imputation strategy 306 may use iterative training in order to train one or more ML models for identification of key collisions in account metadata. Key collisions 308 may be based on features extracted from account metadata, which may include account numbers, a routing number, an account name or type (e.g., checking, savings, etc.), a financial institute or bank name, imputed account key, and/or an n number of account digits (e.g., a last four account digits). Additionally, further checks may be used to determine a validity of an account number and/or completeness of the account metadata. Data may be used to generate hash keys using a hashing algorithm or may be directly compared. Key collisions 308 may therefore be used to determine whether accounts and/or balances have been duplicated in a service provider's system and/or databases. If duplication is identified, account metadata dedupe operation 304 may proceed to dedupe operation 322 directly in diagram 300. Dedupe operation 322 may then be used to dedupe account data for the duplication by removing or otherwise preventing the account data from being processed during one or more operations, such as when utilized for credit underwriting. This may be done without being required to invoke further operations to process transactions and transaction data for account data duplication detection and account dedupe.

However, with certain account data and/or metadata, an account transactions dedupe operation 310 may further provide additional deduplication operations and data dedupe with the service provider's systems. For example, inconsistent or incomplete account records or metadata and/or data and data formats from different financial institutes or computing systems, may cause ML engine 302 to further utilize account transactions dedupe operation 310 for account deduplication. This may also occur with manual statements that may not have transactions and/or issues with data extraction (e.g., optical character recognition). Account transactions dedupe operation 310 may initially perform transaction data extraction, which may correspond to cleaning transaction data (e.g., aggregating, formatting, transforming to particular data structures and/or data tables, and the like). During or prior to cleaning, data may be determined and/or extracted from different physical and/or digital data and/or transaction records. For example, account statements, bank statements, digitally uploaded statements and documents, and/or linked account providers or financial institutions may provide transactions and their data. OCR, image recognition, and other data extraction techniques may be used to extract transaction data. A set of key transaction elements may be designated, such as a date, amount, and/or description of the transaction, however, more, less, or other transaction elements may also be used. Once cleaned by a transaction data extraction 312, features and/or attributes may also be extracted to obtain transaction elements 314 that may be used by one or more ML models for duplicate account identification and deduplication.

An account distance metric may be designated and determined based on transaction collisions between transaction elements 314. For example, the metric may be a distance function that allows for three axioms of identity of indiscernibles, symmetry, and triangle inequality to be satisfied. Thus, each account may be viewed as a set of transactions and a similarity between accounts may correspond to measuring a similarity between two sets (e.g., two accounts). When determining a distance metric for transactions by accounts, a Jaccard similarity, a Sorensen-Dice coefficient, or an overlap coefficient may be used, where, in some embodiments, Overlap coefficient may be prefer able due to relative insensitivity to cardinality. In order to compute pairwise similarity between accounts using gathered transactions, each of the transactions may have a unique identifier generated, such as a hash key using a hashing algorithm or another key that represents the transactions. Pairs of accounts for which a specific transaction is found are then identified and generated. Thereafter, a number of collisions (e.g., the number of overlapping or pair transactions for accounts) are determined and an account similarity metric is calculated.

An initial threshold score or distance metric may be required to identify duplicate accounts. Further, clustering operations 318 may be used with a threshold 320 to determine primary and/or duplicate accounts and balances. Clustering operations 318 may utilize agglomerative clustering, which may correspond to a hierarchical clustering and/or ML algorithm to group object in clusters based on similarities. Agglomerative clustering may use a bottom-up approach where each data point begins in a separate and singular cluster, which are then joined by merging most similar points or clusters into larger clusters. This may work in non-Euclidean space, provide scalability with a number of samples and cluster, and does not require previous knowledge of a number of clusters when using a bottom-up approach. However, other clustering approaches may also be utilized, which may have similar or different approaches and corresponding benefits provided based on those approaches. Threshold 320 may be used to identify and/or control a threshold number of clusters, as well as control the sensitivity of the clustering algorithm (e.g., how similar two or more accounts need to be in order to group using the clustering algorithm. Once duplicated accounts are identified by account metadata dedupe operation 304 and/or account transactions dedupe operation 310, a dedupe operation 322 may be used to remove, delete, change, and/or otherwise dedupe the data within the service provider's system. This further may include adjusting, changing, and/or updating extended credit amounts and/or limits, prior to or after extension of the credit amounts and/or limits to one or more entities.

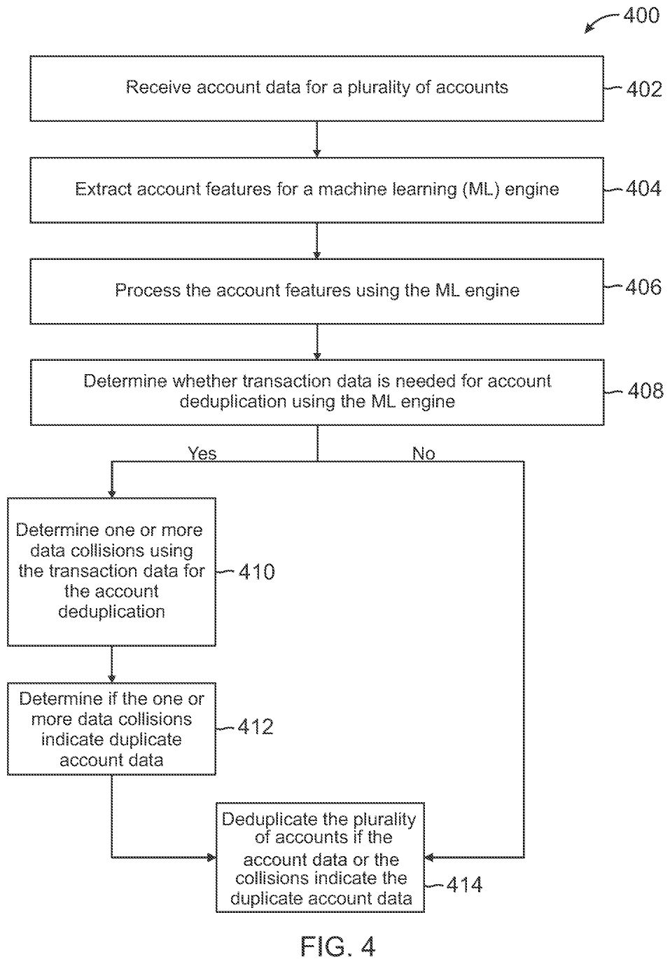

FIG. 4 is an exemplary flowchart 400 for deduplication of accounts using account data collision detected by machine learning models, according to an embodiment. Note that one or more steps, processes, and methods of flowchart 400 described herein may be omitted, performed in a different sequence, or combined as desired or appropriate.

At step 402 of flowchart 400, account data for a plurality of accounts is received. The account data may include account metadata accessed or received from one or more account providers and/or entities using the accounts. The account metadata may include key features used to determine if collisions between those features exist and accounts may be duplicated. At step 404, account features for an ML engine are extracted. The account features may correspond to those input features for one or more ML models of the ML engine, which may be processed to provide an output classification, score, and/or the like for those features. In some embodiments, the account features may correspond to metadata associated with an account identifier or number, a routing or other banking number, financial institution name or information, or the like.

At step 406, the account features are processed using the ML engine. The output classification of the ML engine may correspond to whether sufficient key collisions between the account features exist to identify whether there exist duplicated accounts and/or account balances in the service provider's databases and/or systems. For example, classifications and/or categorizations may be used to intelligently determine, using one or more ML models, whether the key collisions between account features indicate that two or more accounts are duplicates with the service provider's systems. Based on this determination, at step 408, it is determined whether transaction data is needed for account deduplication using the ML engine. The transaction data may further be used to deduplicate accounts, balances, and/or other data that may not initially be detected using account metadata, such as where the account metadata may be incomplete, unavailable, and/or maliciously disguised. If the transactions and transaction data are not necessary and the account metadata may be used for account dedupe (e.g., no, the transaction data is not needed for account deduplication), then flowchart 400 may proceed to step 414, where the plurality of accounts are deduplicated if the account data indicates duplicate account data.

However, if the transaction and transaction data are required at step 408 (e.g., it is determined that, yes, the transaction data is needed for account deduplication), flowchart 400 may proceed to step 410. Transaction data for transactions processed by accounts may be accessed, cleaned, and prepared for processing. Transaction data may be converted hash keys or the like, or such hash keys may be generated for transaction collision detection when occurring in two or more accounts. At step 410, one or more data collisions is determined using the transaction data for the account deduplication. This may be determined by computing pairwise symmetries and calculating an account distance metric based on transaction key similarities. The account distance metric may be calculated using a Jaccard similarity, a Sorensen-Dice coefficient, or an overlap coefficient.

At step 412, it is determined if the one or more data collisions indicate duplicate account data. Determination of the duplicate account data may be detected using a clustering algorithm, such as agglomerative clustering. When doing so, clusters may be generated for data collisions and those clusters of two or more accounts having a threshold number or amount of collisions may be identified. At step 414, the plurality of accounts are deduplicated if the account data or the data collisions indicate the duplicate account data. Deduplication of the account data may include deleting, changing, removing, or otherwise altering the duplicate account data so that the account data and/or balances are not used two or more times by processing systems, such as a credit underwriting system. This may also include changing offers of credit and/or currently extended credit.

Thus, using various embodiments discussed herein, companies can better (e.g., more efficiently and more accurately) deduplicate data that is repeated in databases and with data processing systems, which allows for more intelligent decision-making and provision of services. This may reduce risk for the companies and provide intelligent decisions that automate human functioning to remove user input and decisions when providing services to entities.

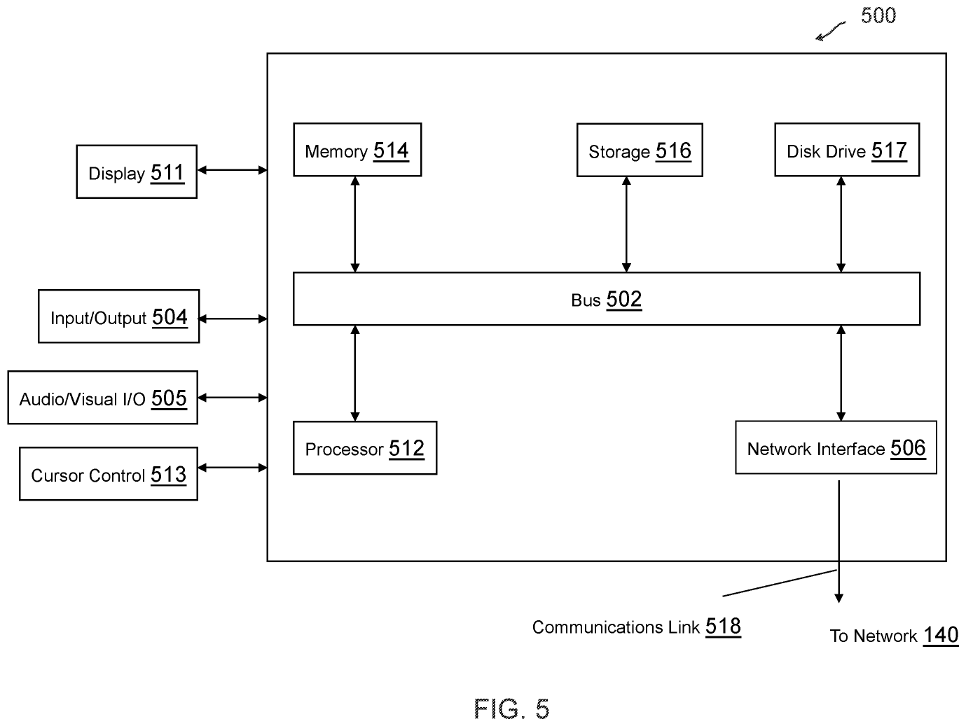

FIG. 5 is a block diagram of a computer system 500 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output (I/O) component 505 may also be included to allow a user to use voice for inputting information by converting audio signals and/or input or record images/videos by capturing visual data of scenes having objects. Audio/visual I/O component 505 may allow the user to hear audio and view images/video including projections of such images/video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
receiving account data for a plurality of accounts with a service provider, wherein the account data comprises an account parameter independent of one or more transactions processed using the plurality of accounts;
extracting account feature data from the account data;
processing the account feature data using an account deduplication machine learning (ML) model-based engine associated with the service provider;
determining, based on the processing the account feature data using the account deduplication ML model-based engine, one or more account data collisions between two of the plurality of accounts;
determining that the one or more account data collisions indicates that the two of the plurality of accounts are a same account; and
deduplicating, with the service provider, the two of the plurality of accounts based on determining that the one or more account data collisions indicates that the two of the plurality of accounts are the same account.

2. The system of claim 1, wherein prior to extracting the account feature data, the operations further comprise:
determining, based on the account data, that the account deduplication ML model-based engine requires transaction data for the one or more transactions with the account data for the deduplicating;
accessing the transaction data for the one or more transactions processed using the plurality of accounts;
extracting transaction feature data from the transaction data; and
determining, based on one or more account distance metrics between the two of the plurality of accounts and the account deduplication ML model-based engine, one or more transaction data collisions of the transaction feature data,
wherein determining the one or more account data collisions is further based on the one or more transaction data collisions.

3. The system of claim 2, wherein the operations further comprise:
defining the one or more account distance metrics by:
computing at least one pairwise account similarity of the transaction feature data using an affinity matrix based at least on the account feature data and the transaction feature data; and
utilizing a clustering operation of the account deduplication ML model-based engine with a similarity threshold to identify the two of the plurality of accounts.

4. The system of claim 3, wherein the clustering operation applies an agglomerative clustering algorithm, and wherein the one or more account distance metrics utilize at least one of a Jaccard similarity, a Sorensen-Dice coefficient, or an overlap coefficient.

5. The system of claim 3, wherein the computing the pairwise account similarity comprises generating a hash key for each of the one or more transactions and pairing the plurality of accounts using the hash keys.

6. The system of claim 1, wherein the service provider extends a credit limit to the two of the plurality of accounts, and wherein the deduplicating comprises at least one of deleting one of the two of the plurality of accounts or lowering the credit limit extended to the two of the plurality of accounts.

7. The system of claim 1, wherein the account data comprises at least one of account identifier data, account name data, or account address data, and wherein the account data is obtained from at least one of extracted optical character recognition (OCR) data from an account statement, digitally uploaded account statements, or linked account providers.

8. A method comprising:
receiving account data for a plurality of accounts with a service provider, wherein the account data comprises an account parameter independent of one or more transactions processed using the plurality of accounts;
extracting account feature data from the account data;
processing the account feature data using an account deduplication machine learning (ML) model-based engine associated with the service provider;
determining, based on the processing the account feature data using the account deduplication ML model-based engine, one or more account data collisions between two of the plurality of accounts;
determining that the one or more account data collisions indicates that the two of the plurality of accounts are a same account; and
deduplicating, with the service provider, the two of the plurality of accounts based on determining that the one or more account data collisions indicates that the two of the plurality of accounts are the same account.

9. The method of claim 8, wherein prior to extracting the account feature data, the method further comprises:
determining, based on the account data, that the account deduplication ML model-based engine requires transaction data for the one or more transactions with the account data for the deduplicating;
accessing the transaction data for the one or more transactions processed using the plurality of accounts;
extracting transaction feature data from the transaction data; and
determining, based on one or more account distance metrics between the two of the plurality of accounts and the account deduplication ML model-based engine, one or more transaction data collisions of the transaction feature data,
wherein determining the one or more account data collisions is further based on the one or more transaction data collisions.

10. The method of claim 9, further comprising:
defining the one or more account distance metrics by:
computing at least one pairwise account similarity of the transaction feature data using an affinity matrix based at least on the account feature data and the transaction feature data; and
utilizing a clustering operation of the account deduplication ML model-based engine with a similarity threshold to identify the two of the plurality of accounts.

11. The method of claim 10, wherein the clustering operation applies an agglomerative clustering algorithm, and wherein the one or more account distance metrics utilize at least one of a Jaccard similarity, a Sorensen-Dice coefficient, or an overlap coefficient.

12. The method of claim 10, wherein the computing the pairwise account similarity comprises generating a hash key for each of the one or more transactions and pairing the plurality of accounts using the hash keys.

13. The method of claim 8, wherein the service provider extends a credit limit to the two of the plurality of accounts, and wherein the deduplicating comprises at least one of deleting one of the two of the plurality of accounts or lowering the credit limit extended to the two of the plurality of accounts.

14. The method of claim 8, wherein the account data comprises at least one of account identifier data, account name data, or account address data, and wherein the account data is obtained from at least one of extracted optical character recognition (OCR) data from an account statement, digitally uploaded account statements, or linked account providers.

15. A non-transitory machine-readable medium having stored thereon machine-readable instructions executable to cause a machine to perform operations comprising:
receiving account data for a plurality of accounts with a service provider, wherein the account data comprises an account parameter independent of one or more transactions processed using the plurality of accounts;
extracting account feature data from the account data;
processing the account feature data using an account deduplication machine learning (ML) model-based engine;
determining, based on the processing the account feature data using the account deduplication ML model-based engine, one or more account data collisions between two of the plurality of accounts;
determining that the one or more account data collisions indicates that the two of the plurality of accounts are a same account; and
deduplicating, with the service provider, the two of the plurality of accounts based on determining that the one or more account data collisions indicates that the two of the plurality of accounts are the same account.

16. The non-transitory machine-readable medium of claim 15, wherein prior to extracting the account feature data, the operations further comprise:
determining, based on the account data, that the account deduplication ML model-based engine requires transaction data for the one or more transactions with the account data for the deduplicating;
accessing the transaction data for the one or more transactions processed using the plurality of accounts;
extracting transaction feature data from the transaction data; and
determining, based on one or more account distance metrics between the two of the plurality of accounts and the account deduplication ML model-based engine, one or more transaction data collisions of the transaction feature data,
wherein determining the one or more account data collisions is further based on the one or more transaction data collisions.

17. The non-transitory machine-readable medium of claim 16, wherein the operations further comprise:
defining the one or more account distance metrics by:
computing at least one pairwise account similarity of the transaction feature data using an affinity matrix based at least on the account feature data and the transaction feature data; and
utilizing a clustering operation of the account deduplication ML model-based engine with a similarity threshold to identify the two of the plurality of accounts.

18. The non-transitory machine-readable medium of claim 17, wherein the clustering operation applies an agglomerative clustering algorithm, and wherein the one or more account distance metrics utilize at least one of a Jaccard similarity, a Sorensen-Dice coefficient, or an overlap coefficient.

19. The non-transitory machine-readable medium of claim 17, wherein the computing the pairwise account similarity comprises generating a hash key for each of the one or more transactions and pairing the plurality of accounts using the hash keys.

20. The non-transitory machine-readable medium of claim 16, wherein the service provider extends a credit limit to the two of the plurality of accounts, and wherein the deduplicating comprises at least one of deleting one of the two of the plurality of accounts or lowering the credit limit extended to the two of the plurality of accounts.
